(19) United States
(12) Patent Application Publication
(10) Pub. No.: US 2004/0055140 A1
(43) Pub. Date: Mar. 25, 2004

(54) Stator winding method of induction motor for compressor

(76) Inventor: Hyun-Rok Cha, Gwangju-city (KR)

Correspondence Address: Todd S. Parkhurst, Holland & Knight LLC, 30th Floor, 131 South Dearborn, Chicago, IL, 60603-5144, US

(21) Appl. No.: 10/667,644

(22) Filed: Sep. 22, 2003

(30) Foreign Application Priority Data
Sep. 24, 2002 (KR) 2002-57712

(51) Int. Cl. H02K 15/00

(52) U.S. Cl. 29/596

(57) ABSTRACT

A stator winding method of an induction motor for a compressor. According to the method, a main winding and a sub winding are wound in a concentrated winding type with a regularity so that the main winding and the sub winding each pass through neighboring slots of the stator, wherein at least two slots, the main winding and the sub winding are overlapped. In here, it is preferred that the main winding and the sub winding are overlapped at four (4) slots in a single phase-two (2) polarity-eight (8) slot type induction motor, overlapped at eight (8) slots in a single phase-two (2) polarity-twelve (12) slot type induction motor, overlapped at four (4) or twelve (12) slots in a single phase-two (2) polarity-sixteen (16) slot type induction motor, overlapped at four (4) slots in a single phase-four (4) polarity-twelve (12) slot type induction motor, and overlapped at six (6) slots in a three phase-two (2) polarity-twelve (12) slot type induction motor. Since the main winding and the sub winding are overlapped at some slots without being concentrated on one slot, there occurs no concentration of magnetic flux. Accordingly, since the occurrence of harmonic frequency due to the concentration of magnetic flux can be prevented, more stable revolving magnetic field can be obtained and an asynchronous torque can be prevented from occurring, improving an efficiency of the single phase induction motor.

### CROSS-REFERENCE TO RELATED APPLICATIONS

This application claims the benefit of Korean Application No. 2002-57712, filed Sep. 24, 2002, in the Korean Intellectual Property Office, the disclosure of which is incorporated herein by reference.

### BACKGROUND

1. Field of the Invention

The present invention relates generally to a stator winding method of an induction motor for use in a compressor.

2. Description of the Related Art

A compressor, as shown in FIG. 1, includes a sealed casing 10, an electronic device unit 20 disposed in the sealed casing 10 to serve as a driving source, and a compression device unit 30 for compressing refrigerant with linear reciprocal movement by the driving force of the electronic device unit 20. The rotational driving force of the electronic device unit 20 is transmitted to a piston 35 of the compression device unit 30 by a crank device that has an eccentric shaft 31 and a connecting rod, and the piston 35 is reciprocated within a bore of a cylinder block 33 in a linear direction, to thereby draw and compress the refrigerant.

The electronic device unit 20 usually uses an induction motor. The induction motor has a stator and a rotor that is rotated by the revolving magnetic field of the electric force generated between the stator and the rotor. On the stator, a main winding and a sub winding are wound around a polar axis of an electric angle 90°. When alternating current (AC) power is supplied to the main winding and the sub winding from a power source (not shown), the sub winding, which is positioned ahead of the main winding by the electrical angle of 90°, is first subjected to the rotational force caused by the revolving magnetic field generated by the electric current. Since the current phase of the sub winding is ahead of the current phase of the main winding due to a capacitor connected in series with the sub winding, the rotor is caused to rotate at a high speed.

FIG. 2 is an exploded perspective view of the induction motor used in a conventional compressor. As shown in FIG. 2, a plurality of stator slots (e.g. twenty-four (24) stator slots) are formed along the stator 21 at a predetermined interval, and a plurality of rotor slots are also formed in the rotor 22. The main winding 23 and the sub winding 24 are wound through the stator slots, while there also is a winding or a permanent magnet (not shown) wound through or inserted into the rotor slots.

FIG. 3 illustrates an order by which the main winding 23 and the sub winding 24 are wound through the twenty-four (24) stator slots 21a of the conventional induction motor. As illustrated, the conventional induction motor has the winding structure of a distributed winding—so called concentric winding for the main winding 23 and the sub winding 24.

In the distributed winding, the main winding 23 enters into the fourteenth slot (14th), and passes through the eleventh (11th), fifteenth (15th), tenth (10th), sixteenth (16th), ninth (9th), seventeenth (17th), eighth (8th), eighteenth (18th) and seventh (7th) slots, and then reenters into the twenty-third (23rd) slot, before passing through the second (2nd), twenty-second (22nd), third (3rd), twenty-first (21st), fourth (4th), twentieth (20th), fifth (5th), nineteenth (19th), and sixth (6th) slots, and then is drawn out. The sub winding 24 enters into the twelfth slot (12th), and passes through the first (1st), eleventh (11th), second (2nd), tenth (10th), third (3rd), ninth (9th), and fourth (4th) slots, and then re-enters into the thirteenth (13th) slot, before passing through the twenty-fourth (24th), fourteenth (14th), twenty-third (23rd), fifteenth (15th), twenty-second (22nd), sixteenth (16th), and twenty-first (21st) slots, and then is drawn out.

In the conventional induction motor, the main winding 23 and the sub winding 24 of the stator 21 are concentrically wound through the slots in an outward or inward direction, inevitably requiring an increased length of the coil end and subsequent cost increases and excessive use of copper.

In addition to the problem of increased length of the coil end due to the distributed winding structure of the main winding 23 and the sub winding 24, the conventional motor also has a problem caused due to the structure in which the winding protrudes from opposing sides of the stator 21. That is, since the winding protrudes from the opposite sides of the stator 21, additional processes like forming, lacing and cleaning are required for the purpose of tidying up the winding, and as a result, productivity deteriorates due to the increased manufacturing processes and other resulting difficulties.

Further, since the main winding 23 and the sub winding 24 each protrude from opposite sides of the stator 21, the size of compressor inevitably unnecessarily increases.

In order to solve the above problems, an induction motor having the winding structure of a concentrated winding was developed and filed in Korean Patent Application No. 10-2002-06666, dated Feb. 6, 2002, by the same assignee of this application, and FIG. 4 is a diagram showing a stator winding method of such an induction motor having the winding structure of a concentrated winding.

Referring to FIG. 4, in the concentrated winding, a main winding 23 and a sub winding 24 are alternatively wound with a predetermined regularity so that each passes through neighboring slots of the stator 21. Referring to FIGS. 4 and 5, the main winding 23 is inserted into the slot 1a, consecutively passed through the slots 2b, 4f, 3e, 5i, 6j, 8n, and 7m, and then is drawn out, while the sub winding 24 is inserted into the slot 2c, consecutively passed through the slots 3d, 5h, 4g, 6k, 7l, 8o, 1p, and then is drawn out.

The concentrated winding in which the main winding 23 and the sub winding 24 are wound by passing through the respective slots 21a of the stator 21, causes the length of the coil end to be shortened, so that a manufacturing cost decreases and an excessive use of copper is prevented. Also, since in the concentrated winding, the main winding 23 and the sub winding 24 wound through the slots 21a of the stator 21 do not protrude from opposite sides of the stator 21, the additional processes like forming, lacing and cleaning to tidy up the main winding 23 and the sub winding 24 is not required, and accordingly, a manufacturing process becomes simpler and more convenient.

The concentrated winding of the stator, however, has disadvantage in that since the main winding 23 and the sub winding 24 are concentrated on each slot, there occurs concentration of magnetic flux, which contributes the frequent occurrence of harmonic frequency. The harmonic frequency may cause a malfunction in the induction motor, such as a noise, an unstable revolving magnetic field and an asynchronous torque, thereby inevitably deteriorating an efficiency of the motor. As illustrated in FIG. 6, the result of an experiment performed for the conventional winding method shows that there occurs an asynchronous torque at 1000 RPM due to the harmonic frequency.

### SUMMARY

The present invention overcomes the above-mentioned problems of the related art. Accordingly, it is an aspect of the present invention to provide a stator winding method of an induction motor for a compressor, which is capable of preventing a magnetic flux concentration and thus removing a harmonic frequency occurrence due to the magnetic flux concentration.

The above aspect is achieved by providing a stator winding method of an induction motor for a compressor, in which a main winding and a sub winding are wound through a plurality of slots formed on the stator. According to the method, the main winding and the sub winding are wound in a concentrated winding type with a regularity so that the main winding and the sub winding each pass through neighboring slots of the stator, wherein at least two slots, the main winding and the sub winding are overlapped.

In here, it is preferred that the main winding and the sub winding are overlapped at four (4) slots in a single phase-two (2) polarity-eight (8) slot type induction motor, overlapped at eight (8) slots in a single phase-two (2) polarity-twelve (12) slot type induction motor, overlapped at four (4) or twelve (12) slots in a single phase-two (2) polarity-sixteen (16) slot type induction motor, overlapped at four (4) slots in a single phase-four (4) polarity-twelve (12) slot type induction motor, and overlapped at six (6) slots in a three phase-two (2) polarity-twelve (12) slot type induction motor.

Also, it is preferred that the main winding is wound in a predetermined turn ratio. For example, in the single phase-two (2) polarity-eight (8) slot type induction motor, the number of winding of the main winding between slots where the main winding is only wound and between slots where the main winding and the sub winding are overlapped has a ratio of 1:0.75.

According to the present invention, since the main winding and the sub winding are overlapped at some slots without being concentrated on one slot, there occurs no concentration of magnetic flux. Accordingly, since the occurrence of harmonic frequency due to the concentration of magnetic flux can be prevented, more stable revolving magnetic field can be obtained and an asynchronous torque can be prevented from occurring, improving an efficiency of the single phase induction motor.

According to a preferred embodiment of the present invention, a stator winding method in a single phase-two polarity-eight slot type induction motor winds the main winding and the sub winding with a regularity so that each is inserted into a predetermined slot and then is wound consecutively through neighboring three (3) slots with reference to the initially entered slot, wherein at four stator slots, the main winding and the sub winding are overlapped.

In here, the main winding is inserted into the slot 2c and is then wound consecutively through the slots 3d, 3e, 4f, 4g, 5h, 6k, 7l, 7m, 8n, 8o and 1p, while the sub winding is inserted into the slot 4g and is then wound consecutively through the slots 5h, 5i, 6j, 6k, 7l, 8o, 1p, 1a, 1b, 2c and 3d.

According to another preferred embodiment of the present invention, a stator winding method in a single phase-two polarity-twelve slot type induction motor winds the main winding and the sub winding with a regularity so that each is inserted into a predetermined slot and then is wound consecutively through neighboring five (5) slots with reference to the initially entered slot, wherein at eight (8) stator slots, the main winding and the sub winding are overlapped.

In here, the main winding is inserted into the slot 1a and is then wound consecutively through the slots 2b, 2c, 3d, 3e, 4f, 4g, 5h, 5i, 6j, 7m, 8n, 8o, 9p, 9q, 10r, 10s, 11t, 11u, and 12v, while the sub winding is inserted into the slot 4g and is then wound consecutively through the slots 5g, 5i, 6j, 6k, 7l, 7m, 8n, 8o, 9p, 10s, 11t, 11u, 12v, 12w, 1x, 1a, 2b, 2c, and 3d.

According to still another embodiment of the present invention, a stator winding method in a single phase-two polarity-sixteen slot type induction motor winds the main winding and the sub winding with a regularity so that each is inserted into a predetermined slot and then is wound consecutively through neighboring seven (7) slots with reference to the initially entered slot, wherein at twelve (12) stator slots, the main winding and the sub winding are overlapped.

In here, the main winding is inserted into the slot 5i and is then wound consecutively through the slots 6j, 6k, 7l, 7m, 8n, 8o, 9p, 9q, 10r, 10s, 11t, 11u, 12v, 13y, 14z, 14a, 15b 15c, 16d, 16e, 1f, 1a, 2b, 2c, 3d, 3e, and 4f, while the sub winding is inserted into the slot 1a and is then wound consecutively through the slots 2b, 2c, 3d, 3e, 4f, 4g, 5h, 5i, 6j, 6k, 7l, 7m, 8n, 9q, 10r, 10s, 11t, 11u, 12v, 12w, 13x, 13y, 14z, 14a, 15b, 15c, and 16d.

According to still another embodiment of the present invention, a stator winding method in a single phase-two polarity-sixteen slot type induction motor winds the main winding and the sub winding with a regularity so that each is inserted into a predetermined slot and then is wound consecutively through neighboring five (5) slots with reference to the initially entered slot, wherein at four (4) stator slots, the main winding and the sub winding are overlapped.

In here, the main winding is inserted into the slot 6k and is then wound consecutively through the slots 7l, 7m, 8n, 8o, 9p, 9q, 10r, 10s, 11t, 14a, 15b, 15c, 16d, 16e, 1f, 1a, 2b, 2c, and 3d, while the sub winding is inserted into the slot 2c and is then wound consecutively through the slots 3d, 3e, 4f, 4g, 5h, 5i, 6j, 6k, 7l, 10s, 11t, 11u, 12v, 12w, 13x, 13y, 14z, 14a, and 15b.

According to still another embodiment of the present invention, a stator winding method in a single phase-four polarity-twelve slot type induction motor winds the main winding and the sub winding with a regularity so that each is inserted into a predetermined slot and then is wound consecutively through neighboring two (2) slots with reference to the initially entered slot, wherein at four (4) stator slots, the main winding and the sub winding are overlapped.

In here, the main winding is inserted into the slot 1a and is then wound consecutively through the slots 2b, 2c, 3d, 4g, 5h, 5i, 6j, 7m, 8n, 8o, 9p, 10s, 11t, 11u, and 12v, while the sub winding is inserted into the slot 12w and is then wound consecutively though the slots 1x, 1a, 2b, 3e, 4f, 4g, 5h, 6k, 7l, 7m, 8n, 9q, 10r, 10s, and 11t.

According to still another embodiment of the present invention, a stator winding method of winding a main winding, a sub winding, and a speed control winding in a three phase-two polarity-twelve slot type induction motor winds the main winding, the sub winding and the speed control winding with a regularity so that each is inserted into a predetermined slot and then is wound consecutively through neighboring three (3) slots with reference to the initially entered slot, wherein at two stator slots, the main winding and the sub winding are overlapped, at other two slots, the main winding and the speed control winding are overlapped, and another two slots, the sub winding and the speed control winding are overlapped.

In here, the main winding is inserted into the slot 2c and is then wound consecutively through the slots 3d, 3e, 4f, 4g, 5h, 8o, 9p, 10r, 10s, and 11t, the sub winding is inserted into the slot 6k and is then passed consecutively through the slots 7l, 7m, 8n, 8o, 9p, 12w, 1x, 1a, 2b, 2c and 3d, while the speed control winding is inserted into the slot 4g and is then wound consecutively through the slots 5h, 5i, 6j, 6k, 7l, 10s, 11t, 11u, 12v, 12w and 1x.

### BRIEF DESCRIPTION OF THE DRAWINGS

The above-mentioned aspects and features of the present invention will be more apparent by describing preferred embodiments of the present invention by referring to the appended drawings, in which:

FIG. 1 is a schematic cross section view showing a general hermetic reciprocal compressor;

FIG. 2 is an exploded perspective view showing an induction motor of the compressor of FIG. 1;

FIG. 3 is a diagram to explain a stator winding method of a conventional induction motor;

FIG. 4 is a diagram to explain a conventional stator winding method of an induction motor, an application of which was filed by the same assignee of this application;

FIG. 5 is a longitudinal cross section view showing an induction motor in which the method of FIG. 4 is applied;

FIG. 6 is a graph showing T-N curve of the induction motor employing the method of FIG. 4;

FIG. 7 is a longitudinal cross section view showing an induction motor for a compressor in which a stator winding method according to one embodiment of the present invention is applied;

FIG. 8 is a diagram to explain the stator winding method according one embodiment of the present invention;

FIGS. 9A and 9B are views showing waveforms of magnetomotive forces to compare a composite magnetomotive force of the induction motor having the general concentrated winding structure of FIG. 5 with that of the induction motor employing the stator winding method of FIG. 7 according to the present invention;

FIG. 10 is a graph showing T-N curve of the induction motor, in which the stator winding method according to the present invention is applied.

FIG. 11 is a diagram to explain one example of a stator winding method for a single phase-two (2) polarity-eight (8) slot type induction motor according to the present invention;

FIG. 12 is a diagram to explain one example of a stator winding method for a single phase-two polarity (2)-sixteen (16) slot type induction motor according to the present invention;

FIG. 13 is a diagram to explain another example of the stator winding method for the single phase-two (2) polarity-sixteen (16) slot type induction motor according to the present invention;

FIG. 14 is a diagram to explain one example of a stator winding method for a single phase-four (4) polarity-twelve (12) slot type induction motor according to the present invention; and

FIG. 15 is a diagram to explain one example a stator winding method for a three (3) phase-two (2) polarity-twelve (12) slot type induction motor according to the present invention;

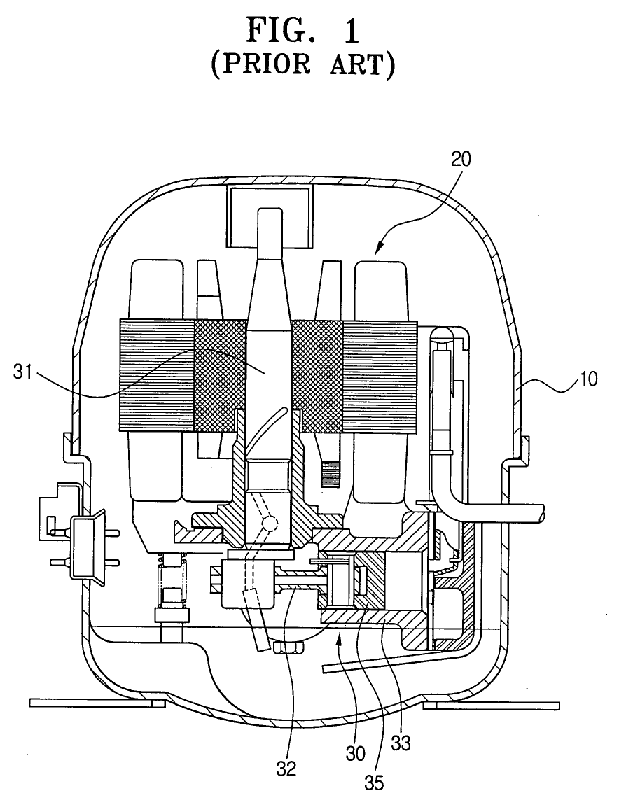

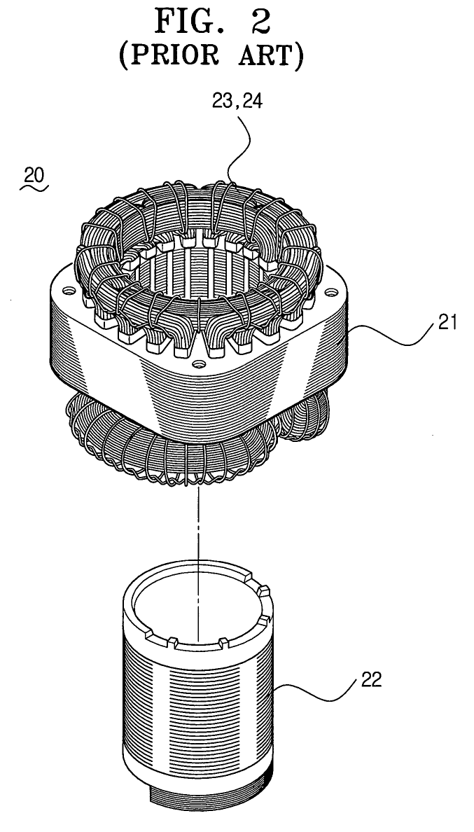

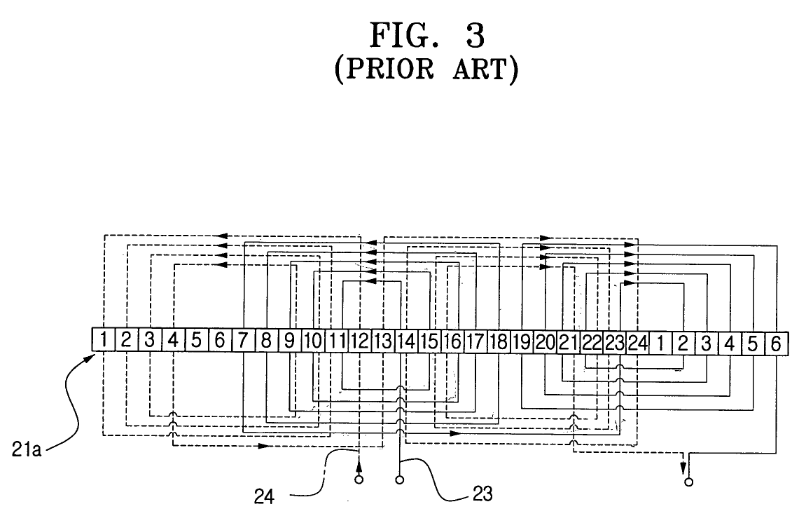

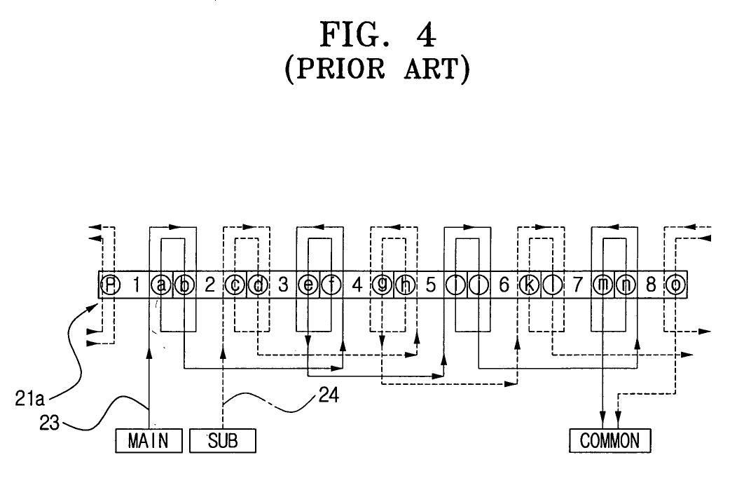

### DETAILED DESCRIPTION OF THE PREFERRED EMBODIMENT

The preferred embodiments of the present invention will be described below in greater detail by referring to the appended drawings.

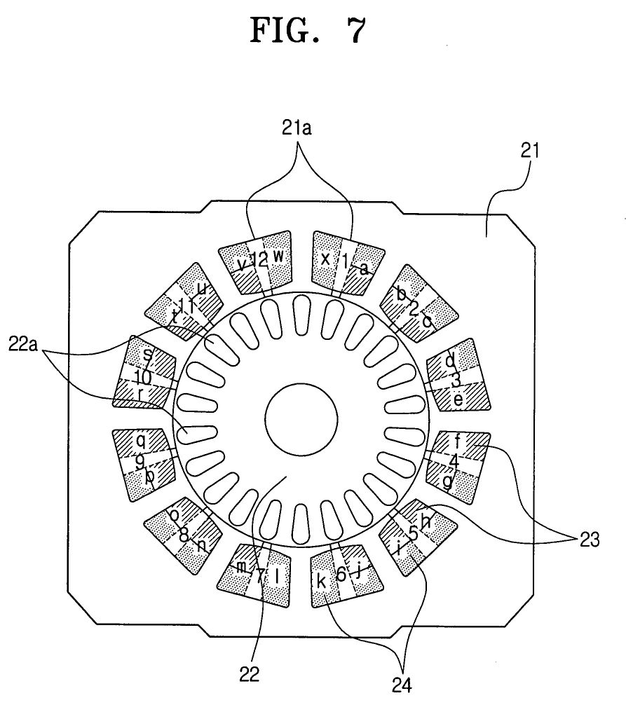

FIG. 7 is a longitudinal sectional view of an induction motor for a compressor employing a stator winding method of a first embodiment of the present invention, in which reference numerals 21 denotes a stator, 22 a rotor, 21a and 22a stator slots and rotor slots, respectively, and 23 and 24 a main winding and a sub winding, respectively.

As shown in FIG. 7, the stator 21 has twelve (12) stator slots 21a through which the main winding 23 and the sub winding 24 are wound according to a predetermined regularity.

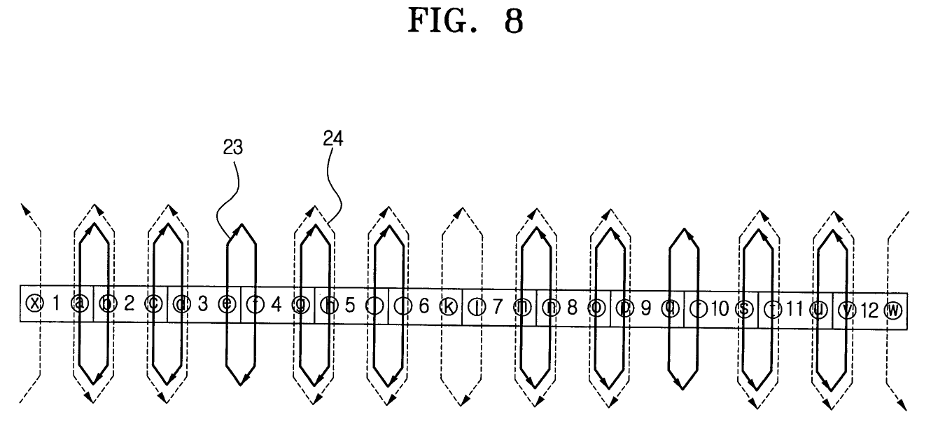

Referring to FIGS. 7 and 8, according to the stator winding method of the present invention, the induction motor has a concentrated winding structure so that the main winding 23 and the sub winding 24 each are inserted into a slot and are passed consecutively through a predetermined number of neighboring slots (e.g. five (5) slots in this embodiment) with reference to the initially entered slot, wherein the main winding 23 and the sub winding 24 are overlapped at some slots (e.g. four (4) slots in this embodiment).

FIGS. 7 and 8 shows an example of a single phase-two (2) polarity-twelve (12) slot type induction motor, in which between slots 3e and 4f and between the slots 9q and 10r is wound the main winding 23 only, while between slots 6k and 7l and between 1x and 12w is wound the sub winding 24 only. At the remaining slots, e.g., between the slots 1a and 2b, 2c and 3d, 4g and 5h, 5i and 6j, 7m and 8n, 8o and 9p, and 10s and 11t, and 11u and 12v, the main winding 23 and the sub winding 24 are overlapped.

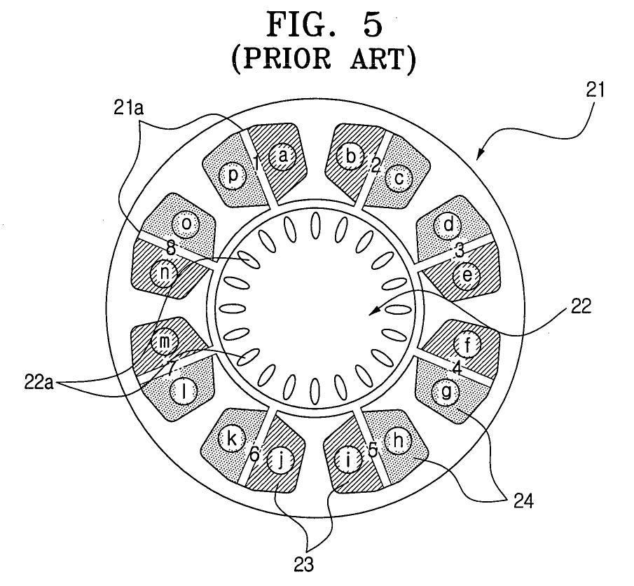

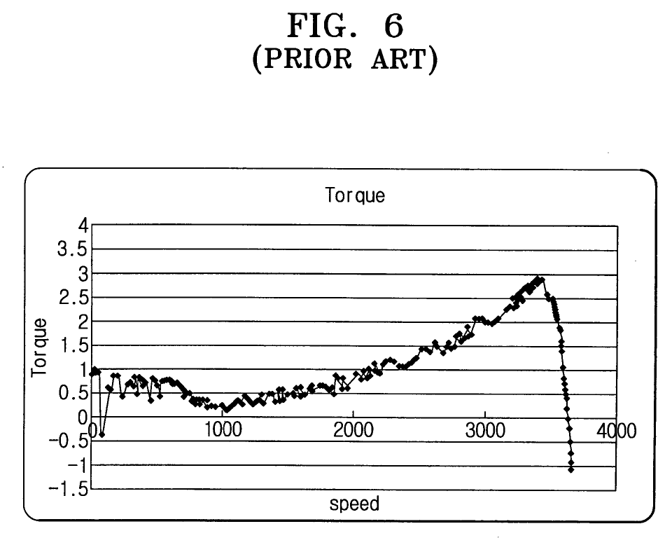

That is, compared to the precedent concentrated winding structure of the same assignee of this application, in which the main winding 23 and the sub winding 24 are concentrated on each slot as shown in FIG. 5, causing the concentration of magnetic flux and subsequent frequent occurrence of harmonic frequency, the concentrated winding structure according to the present invention has the main winding 23 and the sub winding overlapped at the plurality of slots so that the main winding 23 and the sub winding 24 are not concentrated on the slots and are wound through the whole slots evenly. Accordingly, the concentration of magnetic flux becomes loosened and thus the occurrence of harmonic frequency decreases.

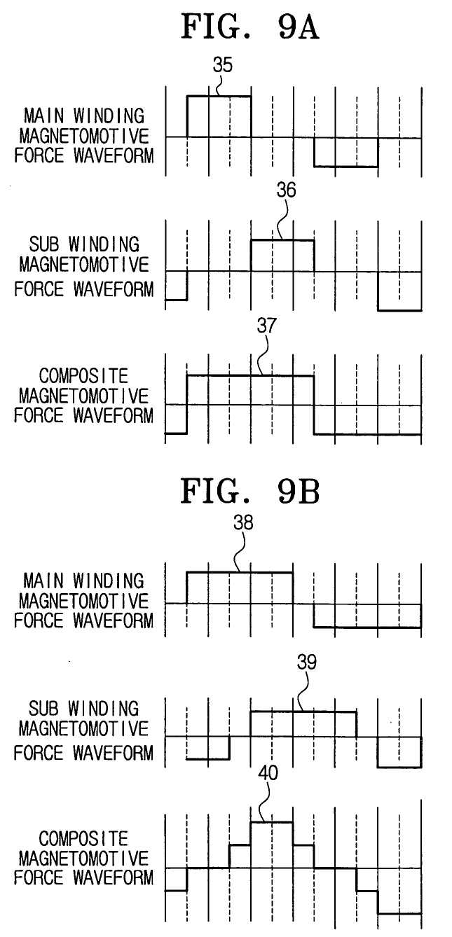

The principle based on which the occurrence of the harmonic frequency decreases is described in greater detail with reference to FIGS. 9A and 9B.

FIG. 9A shows waveform of magnetomotive forces occurring in the induction motor having the precedent concentrated winding structure as shown in FIG. 5. In here, a composite magnetomotive force 37 obtained by combining a main winding magnetomotive force 35 into a sub winding magnetomotive force 36 is a factor that interferes the induction motor. As shown in FIG. 9A, since the waveform of the composite magnetomotive force 37 is similar to a square wave, it inevitably has much more harmonic frequencies.

Meanwhile, in the induction motor employing the stator winding method according to the present invention, a waveform of composite magnetomotive force 40 obtained by combining a waveform of a main winding magnetomotive force 38 and a waveform of a sub winding magnetomotive force 39 is similar to a sinusoidal wave as shown in FIG. 9B. Accordingly, there occurs less the harmonic frequency.

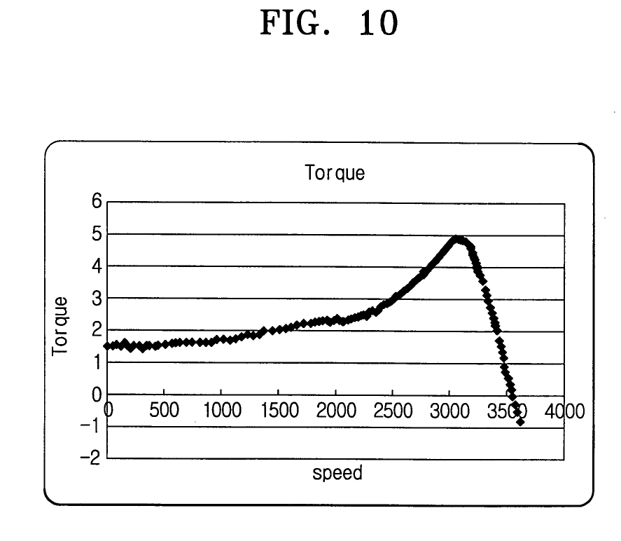

A result of an experiment shows that there occurs no asynchronous torque with the stator winding method according to the present invention as shown in a T-N curve comparison graph of FIG. 10.

More specifically, referring back to FIG. 8, in the induction motor employing the stator winding method according to one embodiment of the present invention, the main winding 23 is inserted into the slot 1a and is then wound consecutively through the slots 2b, 2c, 3d, 3e, 4f, 4g, 5h, 5i, 6j, 7m, 8n, 8o, 9p, 9q, 10r, 10s, 11t, 11u, and 12v, while the sub winding 24 is inserted into the slot 4g and is then wound consecutively through the slots 5g, 5i, 6j, 6k, 7l, 7m, 8n, 8o, 9p, 10s, 11t, 11u, 12v, 12w, 1x, 1a, 2b, 2c and 3d.

As a result, the main winding 23 and the sub winding are overlapped between the slots 1a and 2b, 2c and 3d, 4g and 5h, 5i and 6j, 7m and 8n, 8o and 9p, 10s and 11t, and 11u and 12v. That is, the main winding 23 and the sub winding 24 are wound through whole the stator slots evenly so that the waveform of the magnetomotive force is similar to the sinusoidal wave, causing the concentration of the magnetic flux to be loosened.

Also, if the main winding 23 and the sub winding 24 are wound in a predetermined turn ratio, not at the same revolutions, the waveform of the magnetomotive force becomes more closely similar to the sinusoidal wave.

For example, in FIG. 8, it is assumed that the number of winding of the main winding 24 between the slots 3e and 4f is 100. If the number of winding of the main winding 23 between the slots 2c and 3d and the slots 4g and 5h is 75, and the number of winding of the main winding 23 between the slots 1a and 2b and the slots 5i and 6j is 35, the waveform of the magnetomotive force is more closely similar to the sinusoidal wave, resulting in decrease of the harmonic frequency.

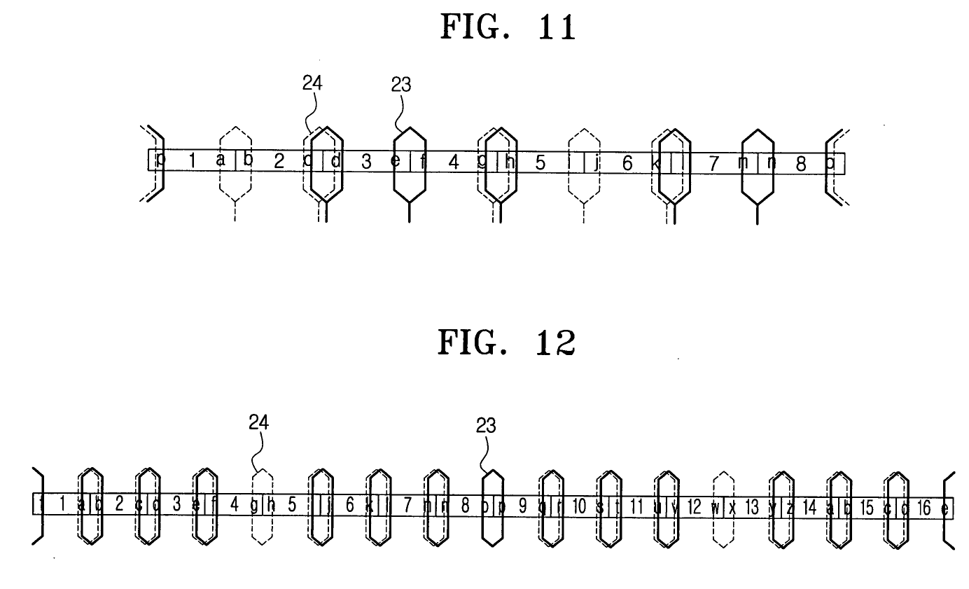

FIG. 11 is a diagram showing a method of winding a main winding 23 and a sub winding 24 through eight (8) slots arranged on a stator of a single phase-two polarity-eight slot type induction motor according to a second embodiment of the present invention.

According to this embodiment, the main winding 23 and the sub winding 24 are respectively wound with a regularity so that each is inserted into a predetermined slot and is then wound consecutively through neighboring three (3) slots with reference to the initially entered slot, wherein at the four (4) slots, the main winding 23 and the sub winding 24 are overlapped.

More specifically, the main winding 23 is instead into the slot 2c and is then wound consecutively the slots 3d, 3e, 4f, 4g, 5h, 6k, 7l, 7m, 8n, 8o, and 1p, while the sub winding 24 is inserted into the slot 4g and is then wound consecutively through the slots 5h, 5i, 6j, 6k, 7l, 8o, 1p, 1a, 1b, 2c, and 3d. Accordingly, the main winding 23 and the sub winding 24 are overlapped between the slots 2c and 3d, 4g and 5h, 6k and 7l, and 8o and 1p.

At this point, it is preferred that the main winding 23 is wound in a predetermined turn ratio. For example, if the number of winding of the main winding 23 between the slots 3e and 4f is 100, preferably, the number of winding of main winding 24 between the slots 2c and 3d and the slots 4g and 5h is 75.

FIG. 12 is a view showing a method of winding a main winding 23 and a sub winding 24 through sixteen (16) slots arranged on a stator of a single phase-two polarity-sixteen (16) slots type induction motor according to a third embodiment of the present invention.

According to this embodiment, the main winding 23 and the sub winding 24 are respectively wound with a regularity so that each is inserted into a predetermined slot and is then wound consecutively through neighboring seven (7) slots with reference to the initially entered slot, wherein at twelve (12) stator slots, the main winding 23 and the sub winding 24 are overlapped.

More specifically, the main winding 23 is inserted into the slot 5i and is then wound consecutively through the slots 6j, 6k, 7l, 7m, 8n, 8o, 9p, 9q, 10r, 10s, 11t, 11u, 12v, 13y, 14z, 14a, 15b, 15c, 16d, 16e, 1f, 1a, 2b, 2c, 3d, 3e, and 4f, while the sub winding 24 is inserted into the slot 1a and is then wound consecutively through the slots 2b, 2c, 3d, 3e, 4f, 4g, 5h, 5i, 6j, 6k, 7l, 7m, 8n, 9q, 10r, 10s, 11t, 11u, 12v, 12w, 13x, 13y, 14z, 14a, 15b, 15c, and 16d. Accordingly, the main winding 23 and the sub winding 24 are overlapped between the slots 1a and 2b, 2c and 3d, 3e and 4f, 5i and 6j, 6k and 7l, 7m and 8n, 9q and 10r, 10s and 11t, 11u and 12v, 13y and 14z, 14a and 15b, and 15c and 16d.

At this point, it is preferred that the main winding 23 is wound in a predetermined turn ratio. For example, it is assumed that the number of winding of the main winding 23 between the slots 8o and 9p is 100. If the number of winding of the main winding 23 between the slots 7m and 8n and the slots 9q and 10r is 75, the number of winding of the main winding 23 between the slots 6k and 7l and the slots 10s and 11t is 54, and the number of winding of the main winding 23 between the slots 5i and 6j and the slots 11u and 12v is 35, the waveform of the magnetomotive force is more closely similar to the sinusoidal wave, resulting in decrease of the harmonic frequency.

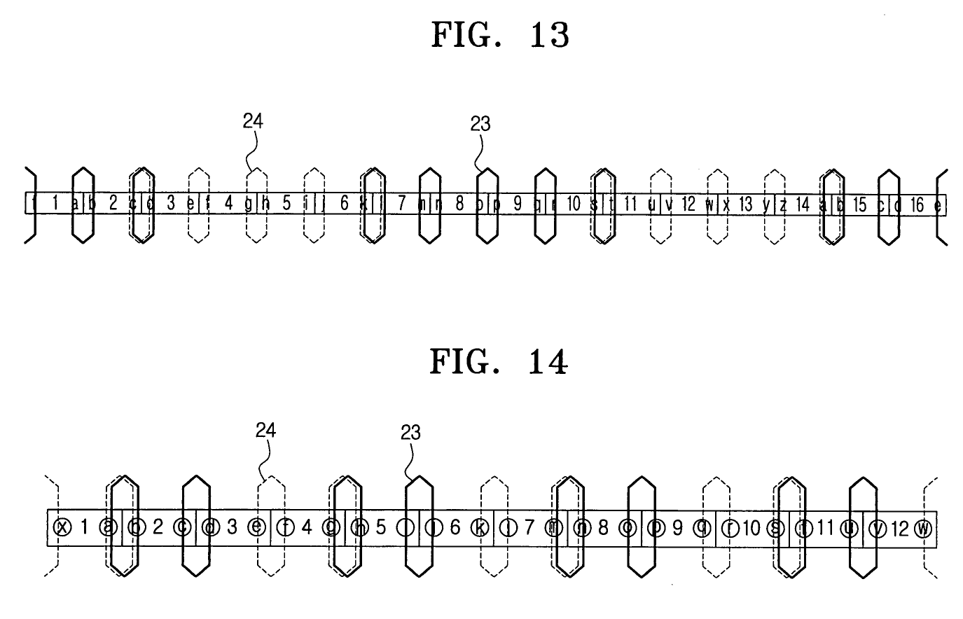

Meanwhile, according to another embodiment for the single phase-two polarity-sixteen slot type induction motor, as shown in FIG. 13, the main winding 23 and the sub winding 24 are respectively wound with a regularity so that each is inserted into a predetermined slot and is then wound consecutively through neighboring five slots with reference to the initially entered slot, wherein at four (4) slots, the main winding 23 and the sub winding 24 are overlapped.

In here, the main winding 23 is inserted into the slot 6k and is then wound consecutively through the slots 7l, 7m, 8n, 8o, 9p, 9q, 10r, 10s, 11t, 14a, 15b, 15c, 16d, 16e, 1f, 1a, 2b, 2c and 3d, while the sub winding 24 is inserted into the slot 2c and is then wound consecutively through the slots 3d, 3e, 4f, 4g, 5h, 5i, 6j, 6k, 7l, 10s, 11t, 11u, 12v, 12w, 13x, 13y, 14z, 14a and 15b. Accordingly, the main winding 23 and the sub winding 24 are overlapped between the slots 2c and 3d, 6k and 7l, 10s and 11t, and 14a and 15b.

At this point, it is preferred that the main winding 23 is wound in a predetermined turn ratio. For example, it is assumed that the number of winding of the main winding 23 between the slots 7m and 8n, the slots 8o and 9p, and the slots 9q and 10s is 100. If the number of winding of the main winding 23 between the slots 6k and 7l and the slots 10s and 11t is 75, the waveform of the magnetomotive force is more closely similar to the sinusoidal wave, resulting in decrease of the harmonic frequency.

FIG. 14 is a view showing a method of winding a main winding 23 and a sub winding 24 through twelve (12) slots arranged on a stator of a single phase-four (4) polarity-twelve (12) slot type induction motor according to a fourth embodiment of the present invention.

According to this embodiment, the main winding 23 and the sub winding 24 are respectively wound with a regularity that each is inserted into a predetermined slot and is then wound consecutively through the neighboring two slots with reference to the initially entered slot, wherein at four stator, the main winding 23 and the sub winding are overlapped.

More specifically, the main winding 23 is inserted into the slot 1a and is then wound consecutively through the slots, 2b, 2c, 3d, 4g, 5h, 5i, 6j, 7m, 8n, 8o, 9p, 10s, 11t, 11u, and 12v, while the sub winding 24 is inserted into the slot 12w and is then wound consecutively through the slots 1x, 1a, 2b, 3e, 4f, 4g, 5h, 6k, 7l, 7m 8n, 9q, 10r, 10s, and 11t. Accordingly, the main winding 23 and the sub winding 24 are overlapped between the slots la and 2b, 4g and 5h, 7m and 8n, and 10s and 11t.

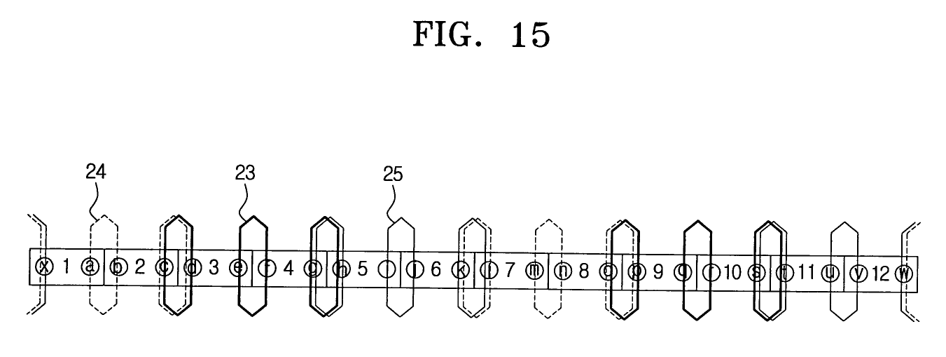

Finally, FIG. 15 is a view showing a method of winding a main winding 23, a sub winding 24, and a speed control winding 25 through twelve (12) slots arranged on a stator of three (3) phase-two (2) polarity-twelve (12) slot type induction motor according to a fifth embodiment of the present invention.

As shown in FIG. 15, the main winding 23, the sub winding 24, and the speed control winding 25 each are inserted into a predetermined slot and are then wound consecutively through the neighboring three slots with reference to the initially entered slot, so that at two stator slots, the main winding 23 and the sub winding 24 are overlapped, at other two slots, the main winding 23 and the speed control winding 25 are overlapped, and another two slots, the sub winding 24 and the speed control winding 25 are overlapped.

More specifically, the main winding 23 is inserted into the slot 2c and is then wound consecutively through the slots 3d, 3e, 4f, 4g, 5h, 8o, 9p, 9q, 10r, 10s, while the sub winding 24 is inserted into the slot 6k and is then wound consecutively through the slots 7l, 7m, 8n, 8o, 9p, 12w, 1x, 1a, 2b, 2c and 3d. Meanwhile, the speed control winding 25 is inserted into the slot 4g and is then wound consecutively through the slots 5h, 5i, 6j, 6k, 7l, 10s, 11t, 11u, 12v, 12w, and 1x. Accordingly, between slots 4g and 5h and between the slots 10s and 11t, the main winding 23 and the speed control winding 25 are overlapped, between slots 2c and 3d and between the slots 8o and 9p, the main winding 23 and the sub winding 24 are overlapped, and between the slots 6k and 7l and between the slots 12w and 1x, the sub winding 24 and the speed control winding 25 are overlapped.

At this point, it is preferred that the main winding 23 is wound in a predetermined turn ratio. For example, it is assumed that the number of winding of the main winding 23 between the slots 3e and 4f is 100. If the number of winding of the main winding 23 between the slots 2c and 3d and the slots 4g and 5hr is 75, the waveform of the magnetomotive force is more closely similar to the sinusoidal wave, resulting in decrease of the harmonic frequency.

The above descriptions are about the stator winding methods which are different according to a type of the induction motor. Although there is a little difference in the stator winding methods as described above according to embodiments of the present invention, the induction motors having the stators wound by the main winding 23 and the sub winding 24 through the plurality of stators accomplish the same effects in any embodiment.

As described above, since the main winding 23 and the sub winding 24 wound through the plurality of slots have the concentrated winding structure, the length of a coil end is shortened and thus a manufacturing cost decreases. Also, excessive use of a copper is prevented and an efficiency of the motor is improved.

Also, according to the present invention, since the main winding 23 and the sub winding 24 are wound through the slots 21a of the stator 21, without protruding excessively, additional processes like forming, lacing and cleaning to tidy up the protruded portions of the main winding 23 and the sub winding 24 can be omitted, and accordingly, the manufacturing process becomes simpler and more convenient, and productivity increases.

Also, if the single phase induction motor according to the present invention is employed in a hermetic reciprocal compressor, since neither the main winding 23 nor the sub winding 24 protrude from the opposite sides of the stator 21 considerably, an advantage of size-reduction of the compressor can also be expected.

Also, since the main winding 23 and the sub winding 24 are overlapped at some slots without being concentrated on one slot, there occurs no concentration of magnetic flux. Accordingly, since the occurrence of harmonic frequency due to the concentration of magnetic flux can be prevented, more stable revolving magnetic field can be obtained and an asynchronous torque can be prevented from occurring, improving an efficiency of the single phase induction motor.

Although the preferred embodiments of the present invention have been described, it will be understood by those skilled in the art that the present invention should not be limited to the described preferred embodiments, but various changes and modifications can be made within the spirit and scope of the present invention as defined by the following claims.

What is claimed is:

1. A stator winding method of an induction motor for a compressor, in which a main winding and a sub winding are wound through a plurality of slots formed on the stator, according to the method, the main winding and the sub winding being wound in a concentrated winding type with a regularity so that the main winding and the sub winding each pass through neighboring slots of the stator, wherein at least two slots, the main winding and the sub winding are overlapped.

2. A stator winding method of winding a main winding and a sub winding through eight (8) slots formed on a stator of a single phase-two polarity-eight slot type induction motor for a compressor, according to the method, the main winding and the sub winding being wound with a regularity so that each is inserted into a predetermined slot and then is wound consecutively through neighboring three (3) slots with reference to the initially entered slot, wherein at four stator slots, the main winding and the sub winding are overlapped.

3. The method of claim 2, wherein the main winding is inserted into the slot 2c and is then wound consecutively through the slots 3d, 3e, 4f, 4g, 5h, 6k, 7l, 7m, 8n, 8o and 1p, while the sub winding is inserted into the slot 4g and is then wound consecutively through the slots 5h, 5i, 6j, 6k, 7l, 8o, 1p, 1a, 1b, 2c and 3d.

4. The method of claim 3, wherein the main winding is wound between the slots 2c and 3d, the slots 3e and 4f, and the slots 4g and 5h in a ratio of 0.75:1:0.75

5. A stator winding method of winding a main winding and a sub winding through twelve (12) slots formed in a stator of a single phase-two polarity-twelve slot type induction motor for a compressor, according to the method, the main winding and the sub winding being wound with a regularity so that each is inserted into a predetermined slot and then is wound consecutively through neighboring five (5) slots with reference to the initially entered slot, wherein at eight (8) stator slots, the main winding and the sub winding are overlapped.

6. The method of claim 5, wherein the main winding is inserted into the slot 1a and is then wound consecutively through the slots 2b, 2c, 3d, 3e, 4f, 4g, 5h, 5i, 6j, 7m, 8n, 8o, 9p, 9q, 10r, 10s, 11t, 11u, and 12v, while the sub winding is inserted into the slot 4g and is then wound consecutively through the slots 5g, 5i, 6j, 6k, 7l, 7m, 8n, 8o, 9p, 10s, 11t, 11u, 12v, 12w, 1x, 1a, 2b, 2c, and 3d.

7. The method of claim 6, wherein the main winding is wound between the slots 1a and 2b, the slots 2c and 3d, the slots 3e and 4f, the slots 4g and 5h, and the slots 5i and 6j in a ratio of 0.35:0.75:1:0.75:0.35.

8. A stator winding method of winding a main winding and a sub winding through sixteen (16) slots formed on a stator of a single phase-two polarity-sixteen slot type induction motor for a compressor, according to the method, the main winding and the sub winding being wound with a regularity so that each is inserted into a predetermined slot and then is wound consecutively through neighboring seven (7) slots with reference to the initially entered slot, wherein at twelve (12) stator slots, the main winding and the sub winding are overlapped.

9. The method of claim 8, wherein the main winding is inserted into the slot 5i and is then wound consecutively through the slots 6j, 6k, 7l, 7m, 8n, 8o, 9p, 9q, 10r, 10s, 11t, 11u, 12v, 13y, 14z, 14a, 15b, 15c, 16d, 16e, 1f, 1a, 2b, 2c, 3d, 3e, and 4f, while the sub winding is inserted into the slot 1a and is then wound consecutively through the slots 2b, 2c, 3d, 3e, 4f, 4g, 5h, 5i, 6j, 6k, 7l, 7m, 8n, 9q, 10r, 10s, 11t, 11u, 12v, 12w, 13x, 13y, 14z, 14a, 15b, 15c, and 16d.

10. The method of claim 9, wherein the main winding is wound between the slots 5i and 6j, the slots 6k and 7l, the slots 7m and 8n, the slots 8o and 9p, the slots 9q and 10r, the slots 10s and 11t, and the slots 11u and 12v in a ratio of 0.35:0.54:0.75:1:0.75:0.54:0.35.

11. A stator winding method of winding a main winding and a sub winding through sixteen (16) slots formed in a stator of a single phase-two polarity-sixteen slot type induction motor for a compressor, according to the method, the main winding and the sub winding being wound with a regularity so that each is inserted into a predetermined slot and then is wound consecutively through neighboring five (5) slots with reference to the initially entered slot, wherein at four stator slots, the main winding and the sub winding are overlapped.

12. The method of claim 11, wherein the main winding is inserted into the slot 6k and is then wound consecutively through the slots 7l, 7m, 8n, 8o, 9p, 9q, 10r, 10s, 11t, 14a, 15b, 15c, 16d, 16e, 1f, 1a, 2b, 2c, and 3d, while the sub winding is inserted into the slot 2c and is then wound consecutively through the slots 3d, 3e, 4f, 4g, 5h, 5i, 6j, 6k, 7l, 10s, 11t, 11u, 12v, 12w, 13x, 13y, 14z, 14a, and 15b.

13. The method of claim 12, wherein the main winding is wound between the slots 6k and 7l, the slots 8o and 9p, and the slots 10s and 11t in a ratio of 0.75:1:0.75.

14. A stator winding method of winding a main winding and a sub winding through twelve (12) slots formed in a stator of a single phase-four polarity-twelve slot type induction motor for a compressor, according to the method, the main winding and the sub winding being wound with a regularity so that each is inserted into a predetermined slot and then is wound consecutively through neighboring two (2) slots with reference to the initially entered slot, wherein at four stator slots, the main winding and the sub winding are overlapped.

15. The method of claim 14, wherein the main winding is inserted into the slot 1a and is then wound consecutively through the slots 2b, 2c, 3d, 4g, 5h, 5i, 6j, 7m, 8n, 8o, 9p, 10s, 11t, 11u, and 12v, while the sub winding is inserted into the slot 12w and is then wound consecutively though the slots 1x, 1a, 2b, 3e, 4f, 4g, 5h, 6k, 7l, 7m, 8n, 9q, 10r, 10s, and 11t.

16. A stator winding method of winding a main winding, a sub winding, and a speed control winding through twelve (12) slots formed in a stator of a three phase-two polarity-twelve slot type induction motor for a compressor, according to the method, the main winding, the sub winding and the speed control winding being wound with a regularity so that each is inserted into a predetermined slot and then is wound consecutively through neighboring three (3) slots with reference to the initially entered slot, wherein at two stator slots, the main winding and the sub winding are overlapped, at other two slots, the main winding and the speed control winding are overlapped, and another two slots, the sub winding and the speed control winding are overlapped.

17. The method of claim 16, wherein the main winding is inserted into the slot 2c and is then wound consecutively through the slots 3d, 3e, 4f, 4g, 5h, 8o, 9p, 10r, 10s, and 11t, the sub winding is inserted into the slot 6k and is then passed consecutively through the slots 7l, 7m, 8n, 8o, 9p, 12w, 1x, 1a, 2b, 2c and 3d, while the speed control winding is inserted into the slot 4g and is then wound consecutively through the slots 5h, 5i, 6j, 6k, 7l, 10s, 11t, 11u, 12v, 12w and 1x.

18. The method of claim 17, wherein the main winding is wound between the slots 2c and 3d, the slots 3e and 4f, and the slots 4g and 5h in a ratio of 0.75:1:0.75.
